(19) United States
(12) Patent Application Publication
(10) Pub. No.: US 2007/0218222 A1
(43) Pub. Date: Sep. 20, 2007

(54) Inkjet recording media

(75) Inventors: Bruce C. Campbell, Webster, NY (US); Kenneth J. Ruschak, Rochester, NY (US); Thomas P. Nicholas, Rochester, NY (US); Lisa B. Todd, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/378,780

(22) Filed: Mar. 17, 2006

(51) Int. Cl. B41M 5/50

(52) U.S. Cl. 428/32.24

(57) ABSTRACT

The invention relates generally to the field of inkjet recording media and inkjet printing methods. More specifically, the invention relates to a porous base layer of an inkjet recording element, the base layer comprises precipitated calcium carbonate having scalenohedral morphology and ground calcium carbonate.

### FIELD OF THE INVENTION

The invention relates generally to the field of inkjet recording media and printing methods. More specifically, the invention relates to a porous base layer of an inkjet recording element, the base layer comprising precipitated calcium carbonate having scalenohedral morphology and, in addition, ground calcium carbonate.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of an aqueous mixture, for example, comprising water and one or more organic materials such as a monohydric alcohol, a polyhydric alcohol, or the like.

An inkjet recording element typically comprises a support having on at least one surface thereof at least one ink-receiving layer. There are generally two types of ink-receiving layers (IRL's). The first type of IRL comprises a non-porous coating of a polymer with a high capacity for swelling, which non-porous coating absorbs ink by molecular diffusion. Cationic or anionic substances may be added to the coating to serve as a dye fixing agent or mordant for a cationic or anionic dye. Typically, this coating is optically transparent and very smooth, leading to a very high gloss “photo-grade” receiver. However, this type of IRL usually tends to absorb the ink slowly into the IRL and, consequently, the imaged receiver or print is not instantaneously dry to the touch.

The second type of ink-receiving layer or IRL comprises a porous coating of inorganic, polymeric, or organic-inorganic composite particles, a polymeric binder, and optional additives such as dye-fixing agents or mordants. These particles can vary in chemical composition, size, shape, and intra-particle porosity. In this case, the printing liquid is absorbed into the open interconnected pores of the IRL, substantially by capillary action, to obtain a print that is instantaneously dry to the touch. Typically the total interconnected inter-particle pore volume of porous media, which may include one or more layers, is more than sufficient to hold all the applied ink forming the image.

Basically, organic and/or inorganic particles in a porous layer form pores by the interstitial spacing between the particles. The binder is used to hold the particles together. However, to maintain a high pore volume, it is desirable that the amount of binder is as low as possible. Too much binder would start to fill the pores between the particles or beads, which would reduce ink absorption. Too little binder may reduce the integrity of the coating, which could cause cracking. Once cracking starts in a coated layer in an inkjet recording element, typically at the bottom of the layer, it tends to migrate throughout the layer.

A porous IRL that is glossy usually comprises at least two layers, a base layer and a glossy image-receiving top layer. When coated on plain paper, the base layer is laid down underneath the glossy image-receiving layer, that is, the base layer is located between the image-receiving layer and the support. In order to provide a smooth, glossy surface on the image-receiving layer, special coating processes are often utilized, such as cast coating and film transfer coating. Calendering, with heat and pressure, is also used in combination with conventional blade, rod, or air-knife coating on plain paper to produce a glossy image-receiving layer.

In general, inkjet base-layer coatings typically have high dry coverage compared to coatings for common papers. For example, typical dry coverage for inkjet base-layer coatings is 10 grams per square meter or more (≧10 g/m²). The base-layer coatings also have to be highly porous to absorb the aqueous ink carrier solvents deposited during inkjet printing.

For porous coated papers, one of the main functions of the base layer is to provide a sump for the ink fluids. As the quality and density of inkjet images increases, so does the amount of ink applied to the inkjet receiver. For this reason it is important provide sufficient void capacity in the base layer. Although many types of inorganic or organic particles can be used in the base layer, calcium carbonate particles have been found useful to provide enough void capacity when coated on a substrate. Calcium carbonate can be natural (ground) or synthetically made (precipitated) and can come in a variety of sizes and shapes.

The porosity necessary for a porous layer has been achieved by using microporous pigments, that is, pigment particles that are themselves porous. Silica gels and fumed aluminas are examples of microporous pigments. However, these materials can be costly and difficult to disperse at high solids. In dispersion, microporous pigments absorb and immobilize part of the liquid phase with the result that the viscosity of the coating composition greatly increases. At particle concentrations approaching close packing, the liquid in the micropores represents a drying penalty. In addition, formulations too high in viscosity are impractical to handle. Pumping, deaerating, filtering and mixing are examples of standard operations that can be compromised by an overly high viscosity. Microporous pigments can also be difficult to handle in the dry state and to disperse. As a consequence, the quantity of microporous pigments that can be used in a coating composition can be limited. While these operating difficulties can be relieved by adding enough water, the coating composition may be made too dilute for coating and the desired drying efficiency, especially for a base layer.

Highly porous base layers have been achieved by employing structured pigments in which the dispersed particles have low or no internal porosity. These may less expensive than microporous pigments. Structured pigments have a non-spherical morphology that does not allow dense packing in the dried coating. In the coating composition, structured pigments immobilize less water than microporous pigments and so do not have the inherent drying penalty. They may be able to be dispersed at the required concentrations without causing unmanageable viscosity.

Precipitated calcium carbonate (PCC) is an example of a structured pigment that can provide high porosity in inkjet coatings. For example, U.S. Pat. No. 6,150,289 to Chen discloses a coating composition intended for a matte-grade inkjet paper comprising engineered calcined clay dispersed with a cationic polymer and compares this with a composition comprising scalenohedral precipitated calcium carbonate (PCC) particles, binders, and crosslinker. At relatively low solids (less than 35%), no rheology problems are mentioned and no suggestion of mixing different morphologies of precipitated calcium carbonate (PCC) particles is made.

U.S. Pat. No. 5,783,038 to Donigian discloses an inkjet recording element coated with precipitated calcium carbonate (PCC) particles milled and heat-aged in the presence of an organo-phosphonate compound. The precipitated calcium carbonate particles may be selected from scalenohedral, acicular, prismatic or rhombohedral morphology. No teaching is provided regarding preferred particle morphology, a mixture of particle morphologies, or coatability on a manufacturing scale at high solids concentration with rod or blade coating apparatus.

U.S. Pat. No. 6,379,780 to Laney discloses a two-layer film laminate comprising an impermeable base polyester layer and an absorbing top polyester layer comprising a filler of a scalenohedral form of precipitated calcium carbonate (PCC). In this example, the recording elements are produced by an entirely different process comprising extrusion, stretching, and tentering, to generate voids, rather than being coated from aqueous coating composition and dried.

U.S. Pat. No. 6,689,430 to Sadasivan discloses an inkjet recording element comprising a base layer comprising prismatic particles of precipitated calcium carbonate (PCC) and silica gel.

U.S. Pat. No. 5,879,442 to Nishiguchi et al. describes a method of preparing aqueous slurries of mixtures of precipitated calcium carbonate and ground calcium carbonate for coatings of papers. The relative weight proportions of precipitated and ground calcium carbonate particles are from 20:80 to 80:20.

### PROBLEM TO BE SOLVED BY THE INVENTION

Coating and drying methods in the paper coating industry include blade and rod coating, mentioned above, that are capable of high coating speeds that contribute to manufacturing efficiency. Coating compositions for porous layers (sometimes referred to as “coating colors”) comprise a high concentration of solids for drying efficiency and, in fact, common coating methods will not work unless the particles are sufficiently concentrated. Dryers are typically gas fired and operate at temperatures in excess of 200° C. As a result of the high solids concentrations and hot dryers, energy usage and dryer lengths are minimized.

Thicker layers using post-metered methods such as rod and blade require relatively higher solids concentrations, whereas thinner layers may use coatings with relatively lower solids concentrations. Thus, dry coverage increases with coating solids concentration. Typically the solids concentration of coating compositions used for the rod and blade coating of base layers in inkjet media is in the range of 50% to 70% by weight. The solids concentration must be high enough that the particle concentration approaches close packing where flow cannot occur. The viscosity of such coatings typically falls rapidly as shear rate is increased and plateaus at high shear rates to a viscosity value called the high shear viscosity. For rod coating, the high shear viscosity is typically in the range of 0.1 to 1 poise.

The choice of type and shape of calcium carbonate in the base layer has been found to significantly impact the overall void capacity and the rate at which it takes up the applied ink fluid. Precipitated calcium carbonate having scalenohedral morphology, as a pigment by itself, provides absorption of inkjet-printing inks. However, at the concentrations required for coating, scalenohedral precipitated calcium carbonate has been found to exhibit an undesirable flow property called shear thickening and sometimes dilatancy. In this case, viscosity climbs once a certain shear rate is exceeded. The coating composition in effect develops a very high resistance to flow that can make dispersing, mixing, pumping and coating operations impossible. While shear thickening can be eliminated by sufficiently diluting the solids concentration, the desired coating and drying capabilities are thereby lost.

The problem remains to provide a highly porous layer coatable from an aqueous coating composition at high solids concentration for efficient coating and drying.

### SUMMARY OF THE INVENTION

These and other objects are achieved in accordance with the invention, which comprises an inkjet recording element comprising a support having thereon:
(a) a porous image-receiving layer; and
(b) under the porous image-receiving layer, a base layer comprising a polymeric binder and at least 80 percent by weight of inorganic particles, wherein at least 60 percent by weight of the inorganic particles, comprise calcium carbonate, the calcium carbonate comprising at least 45 percent by weight of precipitated calcium carbonate having scalenohedral morphology and at least 5 percent by weight of ground calcium carbonate.

Another aspect of the invention relates to an inkjet printing method comprising the steps of: (a) providing an inkjet printer that is responsive to digital data signals; (b) loading the inkjet printer with the inkjet recording element described above; (c) loading the inkjet printer with an inkjet ink composition; and (d) printing on the inkjet recording element using the inkjet ink composition in response to the digital data signals.

Still another aspect of the present invention relates to a method of manufacturing an inkjet recording element.

The term “porous layer” is used herein to define a layer that is characterized by absorbing applied ink substantially by means of capillary induced flow into voids rather than liquid diffusion through a continuous medium. The porosity is largely based on pores formed by the interstitial spacing between particles, although porosity can be affected by the amount and type of binder. The porosity of a mixture may be predicted to some extent based on the critical pigment volume concentration (CPVC). An inkjet recording element having one or more porous layers, preferably substantially all layers, over the support can be referred to as a porous inkjet recording element.

Particle sizes referred to herein, unless otherwise indicted, are median particle sizes as determined by light scattering measurements of diluted particles dispersed in water, as measured using laser diffraction or photon correlation spectroscopy (PCS) techniques employing NANOTRAC (Microtac Inc.), MALVERN, or CILAS instruments or essentially equivalent means, which information is often provided in product literature. For particle sizes greater than 0.3 micrometers, particle measurements are by a Micromeritics SediGraph® 5100 or equivalent means. For particle sizes not more than about 50 nm, particle measurements are by direct methods, transmission electron microscopy (TEM) of a representative sample or equivalent means. Unless otherwise indicated particle sizes refer to secondary particle size.

As used herein, the terms “over,” “above,” “upper,” “under,” “below,” “lower,” and the like, with respect to layers in inkjet media, refer to the order of the layers over the support, but do not necessarily indicate that the layers are immediately adjacent or that there are no intermediate layers.

In regard to the present method, the term “image-receiving layer” is intended to define a layer that is used essentially as a pigment-trapping layer, dye-trapping layer, or dye-and-pigment-trapping layer, in which the printed image substantially resides throughout the layer. Preferably, an image-receiving layer comprises a mordant for dye-based inks. In the case of a dye-based ink, the image may optionally reside in one or more adjacent image-receiving layers, especially if the layers are thin. Pigment particles tend to be trapped at or near the top of the surface, depending upon the relative pore size and particle size.

In regard to the present method, the term “ink-carrier-liquid receptive layer” (also referred to as a “sump layer” or “base layer”) is used herein to mean a layer under the one or more image-receiving layers, preferably a single image-receiving layer, that absorbs a substantial amount of ink-carrier liquid. In use, a substantial amount, preferably most, of the carrier fluid for the ink is received in the ink-carrier-liquid layer or layers. The base layer is not above an image-containing layer and is not itself an image-containing layer (a pigment-trapping layer or dye-trapping layer). Preferably, there is a single ink-carrier-liquid receptive layer comprising calcium carbonate.

The term “ink-receptive layer” or “ink-retaining layer” broadly includes all layers that are receptive to an applied ink composition, that absorb or trap any part of the one or more ink compositions used to form the image in the inkjet recording element, including the ink-carrier fluid and/or the colorant. An ink-receptive layer, therefore, can include either an image-receiving layer, in which the image is formed by a dye and/or pigment, or an ink-carrier-liquid receptive layer in which the carrier liquid in the ink composition is absorbed during printing, although later removed by drying. Typically, all layers above the support are ink-receptive and the support may or may not be absorptive.

The term “precipitated calcium carbonate” is defined as synthetically produced calcium carbonate, not based on calcium carbonate found in nature. The term “ground calcium carbonate” is defined as calcium carbonate found in nature, not synthetically produced.

The term “plain paper” refers to paper that has less than 1 g/m² of coating applied over raw paper. The term “raw paper” refers to cellulosic paper the surface of which does not have a continuous layer or coating of a separate material over the cellulose fibers of the paper, although the paper may treated with a sizing agent or be impregnated with treatment materials over a portion of the surface.

### ADVANTAGEOUS EFFECT OF THE INVENTION

By use of the present invention, a recording element can be obtained that exhibits high ink capacity and excellent dry time and can be manufactured by coating, using rod coating or other post-metering methods, an aqueous coating composition having a high concentration of solids. It has been found that blending scalenohedral-shaped calcium carbonate with ground calcium carbonate pigment can eliminate shear thickening and allow the scalenohedral calcium carbonate to be used in coating compositions (“colors”) at levels high enough to give excellent absorption of inkjet-printing inks.

### BRIEF DESCRIPTION OF THE DRAWINGS

The above and other objects, features, and advantages of the present invention will become more apparent when taken in conjunction with the following description and figures, wherein:

FIG. 1 is a graph of the viscosity, at increasing shear rates, as measured on a rheometer, for the coating composition of Comparative Example 1, comprising precipitated calcium carbonate having exclusively scalenohedral morphology.

### DETAILED DESCRIPTION OF THE INVENTION

As indicated above, the present invention relates to the use of precipitated calcium carbonate having scalenohedral morphology in a porous base layer of an inkjet recording element. In particular, in one embodiment of the invention, an inkjet recording element comprises a support having thereon:
(a) a porous image-receiving layer; and
(b) under the porous image-receiving layers, a base layer comprising a binder, preferably in an amount of 3 to 20 weight percent, and at least 80 percent by weight of inorganic particles, wherein at least 60 percent by weight of the inorganic particles, preferably at least 70 percent by weight of the inorganic particles, comprise calcium carbonate particles, preferably having an median particle size of 0.1 to 5 micrometers, wherein the calcium carbonate particles comprises at least 45 percent by weight of scalenohedral precipitated calcium carbonate particles and at least 5 percent by weight of ground calcium carbonate particles.

In one preferred embodiment, the calcium-carbonate-containing base layer is used as a substrate or base layer immediately or directly below a porous image-receiving layer. In this case, it is preferred that the voids in the ink-receiving layer are open to (connect with) the voids in the calcium-carbonate-containing base layer for optimal interlayer absorption.

In a preferred embodiment of the invention, the ratio of the scalenohedral calcium carbonate to the particles of ground calcium carbonate is from 90:10 to 50:50, based on the dry weight of the precipitated calcium carbonate particles. Preferably, the scalenohedral calcium carbonate is present in an amount of at least 40 weight percent, preferably at least 50 weight percent based on the total dry weight of all the pore-forming particles in the base layer including optional other inorganic and/or organic particles.

The use of a calcium-carbonate-containing base layer according to the present invention can provide desired or improved porosity compared to other particles, inorganic or inorganic, used in porous base layers of many other inkjet-recording elements. A calcium-carbonate-containing base layer, and its attendant structure, according to the present invention, is capable of providing fast dry times with very heavy ink laydown volumes.

Another aspect of the invention relates to an inkjet printing method comprising the steps of: (a) providing an inkjet printer that is responsive to digital data signals; (b) loading the inkjet printer with the inkjet recording element described above; (c) loading the inkjet printer with a pigmented and/or dye-based inkjet ink; and (d) printing on the inkjet recording element using the inkjet ink in response to the digital data signals.

Calcium carbonate occurs in three crystal structures: calcite, aragonite and (rarely) vaterite. Aragonite is commonly in the acicular form, whereas calcite can form scalenohedral, prismatic, spherical, and rhombohedral forms of calcium carbonate. Aragonite changes to calcite when heated to about 400° C. in dry air.

Calcium carbonate can be natural (ground) or synthetically made (precipitated) and can come in a variety of sizes and shapes.

Precipitated calcium carbonate (PCC) can be produced by several methods but, in the U.S., is normally produced by a carbonation process involving bubbling a gas containing carbon dioxide through an aqueous suspension of calcium hydroxide or milk-of-lime in a carbonator reactor. Other inorganic materials such as alum can be co-precipitated with PCC or can be precipitated onto the surface of the PCC precipitate. U.S. Pat. No. 5,783,038 to Donigan et al., for example, discloses one particular method of making precipitated carbonate pigment, although variations in the specific synthetic pathway, optional additives or agents, process conditions, and post-precipitation physical or chemical treatments, can be used to vary the particle size, morphology, and nature of the pigment surface, as will be understood by the skilled artisan.

The use of additives and dopants in the preparation of precipitated calcium carbonate can change the habit to a specific morphology. Soluble additives can selectively stabilize certain crystal faces of CaCO₃, and, therefore provide control of the habit of CaCO₃ through molecular recognition. Recognition is mediated by electrostatic, geometric and stereochemical interactions between the additives and specific crystal faces. The design and activity of tailor-made additives is now well established and known to the skilled artisan. For example, transition metal cations have a marked impact on the morphology and habit of CaCO₃, even at very low concentrations.

While not wishing to be bound by any particular theory, the present inventors hypothesize that the grinding processes used to produce ultrafine grades of ground calcium carbonate result in a reasonably isomorphic particle shape capable of relatively close packing upon drying a coated layer of a dispersion, whereas the highly anisotropic shape of scalenohedral particles of precipitated calcium carbonate form a more loosely-packed structure exhibiting significantly improved porosity.

Examples of scalenohedral calcium carbonate that can be used in the invention include various ALBACAR PCC products available from Specialty Minerals Inc. (subsidiary of Minerals Technologies Inc.). Scalenohedral PCC materials available from Specialty Minerals include ALBACAR HO, ALBACAR 5970 and ViCALity® Extra Light.

Examples of ground calcium carbonate include HYDROCARB 90 available from Omya, Inc.

The base layer optionally further comprises up to 30% by weight solids of precipitated calcium carbonate particles having other than scalenohedral morphology, for example, prismatic, rhombohedral, or acicular morphology. Examples of other types of precipitated calcium carbonate, which may be used include ALBAGLOS and ALBAFIL PCC's (prismatic), OPACARB PCC (acicular), and ViCALity® Heavy PCC (cubic), products also available from Specialty Minerals Inc. Other companies making PCC's include Pfizer and Solvay.

For use in the calcium-carbonate-containing layer of the present invention, the median size (diameter or equivalent diameter) of the calcium carbonate particles (for each morphology) can suitably vary in length from 0.1 μm to 5 μm, with a preferred size of less than 3 μm, more preferably less than 2 μm, most preferably about 0.3 to 2 μm.

In addition, the base layer of the inkjet recording element optionally comprises up to 20 percent by weight of particles other than inorganic particles, based on the total weight of inorganic particles. Examples of organic particles that may be used in this layer include polymer beads, including but not limited to acrylic resins such as methyl methacrylate, styrenic resins, cellulose derivatives, polyvinyl resins, ethylene-allyl copolymers and polycondensation polymers such as polyesters. Hollow styrene beads are a preferred organic particle for certain applications.

Other examples of organic particles that may be used include organic-inorganic composite particles and core/shell particles such as those disclosed in U.S. Pat. No. 6,492,006 and homogeneous particles such as those disclosed in U.S. Pat. No. 6,475,602, the disclosures of which are hereby incorporated by reference.

Examples of inorganic particles that may be used, in addition to the calcium-carbonate particles in the base layer, include silica gel, alumina, titanium dioxide, clay, talc, calcined clays, barium sulfate, or zinc oxide. In a preferred embodiment of the present invention, the inkjet recording element comprises, in addition to scalenohedral precipitated calcium carbonate and ground calcium carbonate, silica gel in an amount of 10 to 40, preferably 15 to 30 percent by weight, based on the total weight of inorganic particles.

In a preferred embodiment, the median primary particle size of the optional additional organic or inorganic particles is about 0.3 μm (300 nm) to about 5 μm, preferably 0.5 μm (500 nm) to less than 1.0 μm. A plurality of inorganic particles such as alumina may agglomerate into larger secondary particles. As mentioned above, smaller particles provide smaller capillaries, but tend to be more prone to cracking because binder starved in view of the large surface area created by the particles. On the other hand, particles that are too large may be brittle or prone to cracking because of fewer contact points, for example, if the coating has a thickness equal to only a few beads making up the dried coating.

In a preferred embodiment of the invention, the porous calcium-carbonate-containing layer comprises between 75% by weight and 98% by weight of particles and between about 2% and 25% by weight of a polymeric binder, preferably from about 82% by weight to about 96% by weight of particles and from about 18% by weight to about 4% by weight of a polymeric binder, most preferably about 4 to 10% by weight of binder.

As mentioned above, the amount of binder is desirably limited, because when ink is applied to inkjet media, the (typically aqueous) liquid carrier tends to swell the binder and close the pores and may cause bleeding or other problems. Preferably, therefore, the base layer comprises less than 25 weight percent of binder, to maintain porosity, although higher levels of binder may be used in some cases to prevent cracking.

Any suitable polymeric binder may be used in the base layer of the inkjet recording element employed in the invention. In a preferred embodiment, the polymeric binder may be a compatible, preferably hydrophilic polymer such as poly(vinyl alcohol), poly(vinyl pyrrolidone), gelatin, cellulose ethers, poly(oxazolines), poly(vinylacetamides), partially hydrolyzed poly(vinyl acetate/vinyl alcohol), poly(acrylic acid), poly(acrylamide), poly(alkylene oxide), sulfonated or phosphated polyesters and polystyrenes, casein, zein, albumin, chitin, chitosan, dextran, pectin, collagen derivatives, collodian, agar-agar, arrowroot, guar, carrageenan, tragacanth, xanthan, rhamsan and the like. Preferably, the hydrophilic polymer is poly(vinyl alcohol), hydroxypropyl cellulose, hydroxypropyl methyl cellulose, a poly(alkylene oxide), poly(vinyl pyrrolidinone), poly(vinyl acetate) or copolymers thereof or gelatin. In general, good results are also obtained with polyurethanes, vinyl acetate-ethylene copolymers, ethylene-vinyl chloride copolymers, vinyl acetate-vinyl chloride-ethylene terpolymers, acrylic polymers, or derivatives thereof. Preferably, the binder is a water-soluble hydrophilic polymer, most preferably polyvinyl alcohol or the like.

Other binders can also be used such as hydrophobic materials, for example, poly(styrene-co-butadiene), polyurethane latex, polyester latex, poly(n-butyl acrylate), poly(n-butyl methacrylate), poly(2-ethylhexyl acrylate), copolymers of n-butylacrylate and ethylacrylate, copolymers of vinylacetate and n-butylacrylate, and the like. A poly(styrene-co-butadiene) latex is preferred. Mixtures of hydrophilic and latex binders are useful, and a mixture of PVA with a poly(styrene-co-butadiene) latex is particularly preferred.

In order to impart mechanical durability to the calcium-carbonate-containing layer, crosslinkers which act upon the binder discussed above may be added in small quantities. Such an additive improves the cohesive strength of the layer. Crosslinkers such as carbodiimides, polyfunctional aziridines, aldehydes, isocyanates, epoxides, polyvalent metal cations, vinyl sulfones, pyridinium, pyridylium dication ether, methoxyalkyl melamines, triazines, dioxane derivatives, chrom alum, zirconium sulfate, boric acid or a borate salt and the like may be used. Preferably, the crosslinker is an aldehyde, an acetal or a ketal, such as 2,3-dihydroxy-1,4-dioxane.

The calcium-carbonate-containing base layer is typically greater than 10 μm in thickness (dried), more preferably at least 15 μm or 20 μm, depending on the presence of other liquid-carrier absorbing layers, most preferably about 25 to 60 μm. For example, in one embodiment, the calcium-carbonate-containing layer is 30 to 70 μm thick. In the case of an inkjet recording element with a porous support such as paper, the preferred thickness of the calcium-carbonate-containing layer may be slightly less, for example, 20 μm to 60 μm thick, preferably at least 25 μm.

The calcium-carbonate-containing base layer according to the present invention is located under at least one image-receiving layer and absorbs a substantial amount of the liquid carrier applied to the inkjet recording element, but substantially less dye or pigment than the overlying layer or layers.

The porous image-receiving layer contains interconnecting voids that can provide a pathway for the liquid components of applied ink to penetrate appreciably into the calcium-carbonate-containing base layer, thus allowing the calcium-carbonate-containing base layer to contribute to the dry time. A non-porous image-receiving layer or a porous image-receiving layer that contains closed cells would not allow the substrate to contribute to the dry time.

Interconnecting voids in an image-receiving layer may be obtained by a variety of methods. For example, the layer may contain particles dispersed in a polymeric binder. The particles may be organic such as poly(methyl methacrylate), polystyrene, poly(butyl acrylate), etc. or inorganic having a median particle size under 300 nm, preferably under 250 nm, more preferably under 200 nm. Preferably, the image-receiving layer comprises inorganic particles of hydrated or unhydrated metallic oxide or silicon oxide. In a preferred embodiment, the image-receiving layer comprises substantially non-aggregated colloidal particles of silica or hydrated or unhydrated alumina, most preferably a hydrated alumina that is an aluminum oxyhydroxide material, for example, boehmite.

The term “hydrated alumina” is herein defined by the following general formula:
Al₂O₃₋ₙ(OH)₂ₙ.mH₂O
wherein n is an integer of 0 to 3, and m is a number of 0 to 10, preferably 0 to 5. In many cases, mH₂O represents an aqueous phase which does not participate in the formation of a crystal lattice, but is able to be eliminated. Therefore, m may take a value other than an integer. However, m and n are not 0 at the same time.

The term “unhydrated alumina” is herein defined by the above formula when m and n are both zero at the same time and includes fumed alumina, made in a dry phase process or anhydrous alumina Al₂O₃ made by calcining hydrated alumina. As used herein, such terms as unhydrated alumina apply to the dry materials used to make coating compositions during the manufacture of the inkjet recording element, notwithstanding any hydration that occurs after addition to water.

A crystal of the hydrated alumina showing a boehmite structure is generally a layered material the (020) plane of which forms a macro-plane, and shows a characteristic diffraction peak. Besides a perfect boehmite, a structure called pseudo-boehmite and containing excess water between layers of the (020) plane may be taken. The X-ray diffraction pattern of this pseudo-boehmite shows a diffraction peak broader than that of the perfect boehmite. Since perfect boehmite and pseudo-boehmite may not be clearly distinguished from each other, the term “boehmite” or “boehmite structure” is herein used to include both unless indicated otherwise by the context. For the purposes of this specification, the term “boehmite” implies boehmite and/or pseudoboehmite.

Boehmite and pseudoboehmite are aluminum oxyhydroxides which is herein defined by the general formula γ-AlO(OH)xH₂O, wherein x is 0 to 1. When x=0 the material is specifically boehmite as compared to pseudo-boehmite; when x>0 and the materials incorporate water into their crystalline structure, they are known as pseudoboehmite. Boehmite and pseudoboehmite are also described as Al₂O₃.zH₂O where, when z=1 the material is boehmite and when 1<z<2 the material is pseudoboehmite. The above materials are differentiated from the aluminum hydroxides (e.g. Al(OH)₃, bayerite and gibbsite) and diaspore (α-AlO(OOH) by their compositions and crystal structures. As indicated above, boehmite is usually well crystallized and, in one embodiment, has a structure in accordance with the x-ray diffraction pattern given in the JCPDS-ICDD powder diffraction file 21-1307, whereas pseudoboehmite is less well crystallized and generally presents an XRD pattern with relatively broadened peaks with lower intensities.

The term “aluminum oxyhydroxide” is herein defined to be broadly construed to include any material whose surface is or can be processed to form a shell or layer of the general formula γ-AlO(OH)xH₂O (preferably boehmite), such materials including aluminum metal, aluminum nitride, aluminum oxynitride (AlON), α-Al₂O₃, γ-Al₂O₃, transitional aluminas of general formula Al₂O₃, boehmite (γ-AlO(OH)), pseudoboehmite ((γ-AlO(OH)).xH₂O where 0<x<1), diaspore (α-AlO(OH)), and the aluminum hydroxides (Al(OH)₃) of bayerite and gibbsite. Thus, aluminum oxyhydroxide particles include any finely divided materials with at least a surface shell comprising aluminum oxyhydroxide. In the most preferred embodiment, the core and shell of the particles are both of the same material comprises boehmite with a BET surface area of over 100 m²/g.

Optionally, the image-receiving layer can comprise a mixture of (i) non-aggregated colloidal particles of one or more materials having a median particle size of under 300 nm, preferably 80 to 200 nm, and (ii) aggregated colloidal particles of one or more materials, for example fumed metallic semi-metallic oxide, having a median secondary particle size under 300 nm, preferably 80 to 200 nm, and a primary average particle size of 7 to 40 nm. More preferably, the optional fumed particles are fumed alumina or fumed silica. Examples of useful colloidal particles include hydrated alumina (including aluminum oxyhydroxides such as boehmite), alumina, silica, aluminosilicates, titanium dioxide, zirconium dioxide, and the like. Preferably, the non-aggregated colloidal particles comprise aluminum oxyhydroxide material or colloidal (non-aggregated) silica.

Fumed or pyrogenic particles are aggregates of smaller, primary particles. Although the primary particles are not porous, the aggregates contain a significant void volume, and hence are capable of rapid liquid absorption. These void-containing aggregates enable a coating to retain a significant capacity for liquid absorption even when the aggregate particles are densely packed, which minimizes the inter-particle void volume of the coating. For example, fumed alumina particles, for selective optional use in the present invention, are described in US20050170107 A1, hereby incorporated by reference. Fumed particles are made by a dry process (vapor phase process). In a vapor phase method, flame hydrolysis methods and arc methods have been commercially used. Fumed particles exhibit different properties than non-fumed or hydrated particles. In the case of fumed silica, this may be due to the difference in density of the silanol group on the surface.

Polymeric binders that can be used in the image-receiving layer of the invention include, for example, hydrophilic polymers such as poly(vinyl alcohol), polyvinyl acetate, polyvinyl pyrrolidone, gelatin, poly(2-ethyl-2-oxazoline), poly(2-methyl-2-oxazoline), poly(acrylamide), chitosan, poly(ethylene oxide), methyl cellulose, ethyl cellulose, hydroxyethyl cellulose, hydroxypropyl cellulose, etc. Other binders that can be used include hydrophobic materials, for example, poly(styrene-co-butadiene), polyurethane latex, polyester latex, poly(n-butyl acrylate), poly(n-butyl methacrylate), poly(2-ethylhexyl acrylate), copolymers of n-butylacrylate and ethylacrylate, copolymers of vinylacetate and n-butylacrylate, and the like.

The particle-to-binder weight ratio of the particles and optional binder employed in the porous image-receiving layer can range between about 100:0 and 60:40, preferably between about 100:0 and about 90:10. In general, a layer having particle-to-binder ratios outside the range stated will usually not be sufficiently porous to provide good image quality. In a preferred embodiment of the invention, the volume ratio of the particles to the polymeric binder in the image-receiving layer is from about 1:1 to about 15:1.

Additives that optionally can be included in the image-receiving layer include pH-modifiers like nitric acid, crosslinkers, rheology modifiers, water-retention aides, surfactants, UV-absorbers, biocides, lubricants, dyes, dye-fixing agents or mordants, optical brighteners, and other conventionally known additives. The base layer can independently and optionally include any of the additives found in the image-receiving layer.

An image-receiving layer may be applied to one or both support surfaces through conventional pre-metered coating methods (such as extrusion, curtain or slide hopper coating) or post-metered coating methods (such as blade, air knife, rod, roll coating, and the like). By the term “post-metering method” is meant a method in which the coating composition is metered after coating, by removing excess material that has been coated. By the term “pre-metering method,” also referred to as direct metering method, is meant a method in which the coating composition is metered before coating, for example, by a pump. The choice of coating process typically determines coating speed and particular formulation specifications such as coating solids and coating viscosity.

The image-receiving layer thickness may range from about 1 to about 25 μm, preferably between 2 and 15 μm, more preferably between 2 and 10 μm. most preferably 3 to 6 μm.

The inkjet recording element can be specially adapted for either pigmented inks or dye-based inks, or designed for both. One embodiment of such a recording element comprises a support having thereon in order: (a) a porous pigment-trapping and/or dye-trapping layer comprising inorganic and/or organic particles and a binder; and (b) a base layer that is a calcium-carbonate-containing base layer as described above.

The support may optionally function as an ink-carrier-receptive layer or sump layer in combination with the base layer.

The term “pigment-trapping layer” is used herein to mean that, in use, preferably at least about 75% by weight, more preferably substantially all, of the pigment colorant in the inkjet ink composition used to print an image remains in the pigment-trapping layer.

In the case of pigment-based inks, the calcium-carbonate-containing base layer receives the ink-carrier liquid after it has passed through the porous image-receiving layer where substantially all the pigmented colorant has been removed. In a preferred embodiment, the base layer is present in an amount from about 15 g/m² to about 50 g/m², more preferably from about 20 g/m² to about 45 g/m², more preferably 25 g/m² to about 40 g/m².

A dye mordant can be employed in an image-receiving top layer and any optional intermediate layer between the top layer and the base layer, which mordant can be any material that is substantive to the inkjet dyes. Examples of such mordants include cationic lattices such as disclosed in U.S. Pat. No. 6,297,296 and references cited therein, cationic polymers such as disclosed in U.S. Pat. No. 5,342,688, and multivalent ions as disclosed in U.S. Pat. No. 5,916,673, the disclosures of which are hereby incorporated by reference. Examples of these mordants include polymeric quaternary ammonium compounds, or basic polymers, such as poly(dimethylaminoethyl)-methacrylate, polyalkylenepolyamines, and products of the condensation thereof with dicyanodiamide, amine-epichlorohydrin polycondensates. Further, lecithins and phospholipid compounds can also be used. Specific examples of such mordants include the following: vinylbenzyl trimethyl ammonium chloride/ethylene glycol dimethacrylate; poly(diallyl dimethyl ammonium chloride); poly(2-N,N,N-trimethylammonium)ethyl methacrylate methosulfate; poly(3-N,N,N-trimethyl-ammonium)propyl methacrylate chloride; a copolymer of vinylpyrrolidinone and vinyl(N-methylimidazolium chloride; and hydroxyethylcellulose derivatized with 3-N,N,N-trimethylammonium)propyl chloride. In a preferred embodiment, the cationic mordant is a polymer containing quaternary ammonium groups.

In order to be compatible with the mordant, both the binder and the polymer in the layer or layers in which it is contained should be either uncharged or the same charge as the mordant. Colloidal instability and unwanted aggregation could result if a polymer or the binder in the same layer had a charge opposite from that of the mordant.

In one embodiment, the porous image-receiving layer may comprise particles in an amount ranging from about 95 to about 60 parts by weight, the binder may range from about 40 to about 5 parts by weight, and the dye mordant may range from about 2 parts to about 40 parts by weight. More preferably, the image-receiving layer can, for example, comprises roughly about 80 parts by weight particles, about 10 parts by weight binder, and about 10 parts by weight dye mordant. In this embodiment, the dye-trapping layer is present in an amount from about 1 g/m² to about 25 g/m², preferably in an amount from about 1 g/m² to about 10 g/m², wherein the image-receiving layer is at least 25% thinner, than the base layer, which is present in an amount from about 15 g/m² to about 50 g/m², preferably from about 20 g/m² to about 45 g/m². The porous base layer is designed to receive the ink-carrier liquid after the ink has passed through the porous image-receiving layer where substantially all the dye in a dye-based imaging ink has been removed.

Whatever the particular type of recording element, whether designed for dye-based inks, pigmented inks or both, the recording element comprises, under the calcium-carbonate-containing base layer, a support which support may be opaque, translucent, or transparent. There may be used, for example, plain papers, resin-coated papers, various plastics including a polyester resin such as poly(ethylene terephthalate), poly(ethylene naphthalate) and poly(ester diacetate), polycarbonate resin, fluorine-containing resin such as poly(tetra-fluoro ethylene), metal foil, various glass materials, and the like. In a preferred embodiment, the support is a resin-coated paper or raw (uncoated) paper, more preferably the latter. The thickness of the support employed in the invention can be from about 12 to about 500 μm, preferably from about 75 to about 300 μm.

The support can also comprise an open-pore polyolefin, an open-pore polyester, or an open-pore membrane. An open-pore membrane can be formed in accordance with the known technique of phase inversion. Examples of a porous ink-receiving layers comprising an open-pore membrane are disclosed in U.S. Pat. No. 6,497,941 and U.S. Pat. No. 6,503,607, hereby incorporated by reference. An open-pore polyester is disclosed in U.S. Pat. No. 6,409,334, hereby incorporated by reference in its entirety.

If desired, in order to improve the adhesion of the base layer to the support, the surface of the support may be corona-discharge-treated prior to applying the base layer or solvent-absorbing layer to the support.

Since the inkjet recording element may come in contact with other image recording articles or the drive or transport mechanisms of image-recording devices, additives such as surfactants, lubricants, matte particles and the like may be added to the inkjet recording element to the extent that they do not degrade the properties of interest.

The layers described above, including the base layer, the image-receiving layer, and optional other layers, including subbing layers, overcoats, and intermediate layers between the base layer and the image-receiving layer, may be coated by conventional coating means onto a support material commonly used in this art. Coating methods may include, but are not limited to, wound wire rod coating, slot coating, slide hopper coating, gravure, curtain coating and the like. It may be advantageous, however, to rod coat the base layer. Some of these methods allow for simultaneous coatings of two or more layers, which is preferred from a manufacturing economic perspective. After coating, the inkjet recording element may be subject to calendering or super-calendering to enhance surface smoothness

In another aspect of the invention, the inkjet recording element is manufactured by a method comprising coating a first coating composition for the base layer over a substrate, preferably a paper support, in which the first coating composition is coated by a post-metering method such as blade or rod coating, preferably rod coated. The coating composition is an aqueous composition comprising at least 40 percent by weight solids, preferably 50 to 70 weight percent solids. The solids composition is as described above for the base layer composition of the inkjet recording element. Accordingly the solids comprise a polymeric binder and at least 80% by weight of inorganic particles, wherein at least 60% by weight of the inorganic particles comprise calcium carbonate, the calcium carbonate comprising at least 45 percent by weight of scalenohedral calcium carbonate particles and at least 5% of ground calcium carbonate. After being coated, the first coating composition is dried, calendered, and overcoated, directly or indirectly, with a second coating composition. The first coating composition forms a base layer and the second coating composition forms a porous image-receiving layer, most preferably a single image-receiving layer.

The present invention does not require, but permits, the use or addition of various organic and inorganic materials such as anti-block agents, antistatic agents, plasticizers, dyes, stabilizers, nucleating agents, and other addenda known in the art to any above-described layers. These materials may be incorporated into one or more of the coatings used to make the recording element using known techniques.

Inkjet inks used to image the recording elements of the present invention are well known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. If dyes are used in such compositions, they are typically water-soluble direct or acid type dyes. Such liquid compositions have been described extensively in the prior art including, for example, U.S. Pat. Nos. 4,381,946; 4,239,543; and 4,781,758.

Although the recording elements disclosed herein have been referred to primarily as being useful for inkjet printers, they also can be used as recording media for pen plotter assemblies. Pen plotters operate by writing directly on the surface of a recording medium using a pen consisting of a bundle of capillary tubes in contact with an ink reservoir.

The following examples further illustrate the invention.

### EXAMPLES

Measurements of Shear Thickening

Shear thickening behavior was measured using a standard commercially available instrument called a rheometer. The lower shear instrument used to make the rheology measurements was the ARES (Advanced Rheometric Expansion System) rheometer (made by TA Instrument, 1 Possumtown Rd., Piscataway N.J., 08854). The Couette fixture was used. The high shear instrument used to make rheology measurements was the Rheostress® RS150 rheometer (made by HAAKE Instruments Inc., 53 W. Century Road, Paramus, N.J. 07652). The double gap DG41 coaxial cylinders and high shear HS25 fixtures were used.

Shear-rate sweeps was performed in accordance with the common measurement practice. Shear sweeps are viscosity measurements over a range of values for shear rate. Three or four sweeps were carried out sequentially:

Sweep 1, low shear rate to high shear rate;

Sweep 2, high shear rate to low shear rate;

Sweep 3, low shear rate to high rate; and, in some cases,

Sweep 4, high shear rate to low shear rate.

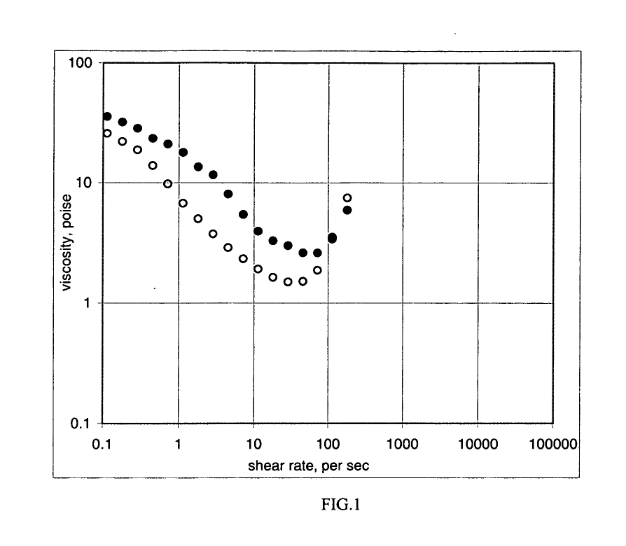

The first sweep typically breaks down any pigment structure in the coating color and is not shown. In FIG. 1, the second sweep is shown by open symbols, and the third sweep is shown by solid symbols.

The higher shear rheometer shears the sample at a shear rate of 300 per sec before commencing the shear sweeps. Shear rates up to 50,000 per sec are achievable on the higher shear rheometer. Typically, the viscosity reaches a constant value at high shear rates. This limiting viscosity is usually called the high shear viscosity and is believed to be the viscosity relevant to the coating process. A high shear viscosity exceeding about 0.1 poise is necessary for rod coating.

### Comparative Example 1

A coating color comprising 85 parts (dry) ALBACAR 5970 precipitated calcium carbonate, a structured pigment having scalenohedral morphology, and 15 parts (dry) CP692NA latex binder (Dow Chemical) was prepared in a lab at a solids concentration of 50.7%, the level anticipated for rod coating. The lower shear rheometer showed an abrupt rise in viscosity commencing at a shear rate of about 100 per sec indicating shear thickening behavior, as shown in FIG. 1. The higher shear rheometer quickly overloaded during the initial shearing at 300 per sec and failed to produce any data, and in particular a high shear viscosity could not be determined. In addition, difficulty was encountered loading the sample into the small gap. Upon unloading after the failed measurement, the sample appeared chalky. The composition also appeared to exhibit dilatancy.

### Example 2

This example shows the preparation of base layer coating compositions, at 50% solids, comprising high concentrations of scalenohedral calcium carbonate, up to 95% of the total calcium carbonate. A Comparative Coating Composition A was prepared comprising 50% solids, where ALBACAR HO PCC was 100% of the solids. (ALBACAR HO is a relatively smaller size scalenohedral PCC compared to ALBACAR 5970 precipitated calcium carbonate, mentioned above.) Since ALBACAR HO scalenohedral precipitated calcium carbonate (PCC) is commercially available as a 40% solids dispersion or as a solid, Comparative Coating Composition A was prepared using the available dispersion plus additional dry powdered ALBACAR HO PCC.

Inventive Coating Compositions B and C were prepared at 50% solids using a formula similar to Comparative Coating Composition A, but in which 10% and 5% of the ALBACAR HO was replaced by an equal weight of HYDROCARB 90 GCC, respectively. The compositions were obtained by blade mixing the following specific formulations:

Comparative Coating Composition A (Pigment 100% ALBACAR HO PCC):

(1) 99.5 g of ALBACAR HO-40 precipitated calcium carbonate paste (Specialty Minerals Inc.) at 39 wt. %;
(2) 0.3 g of COLLOID 211 polyacrylate dispersant (Kemira) at 43 wt. %;
(3) 35.2 g of ALBACAR HO precipitated calcium carbonate (Omya, Inc.) at 100 wt. %;
(4) 8.2 g of styrene-butadiene latex CP692NA® (Dow Chemical Co.) at 49 wt. %;
(5)16.0 g of CELVOL 325 polyvinyl alcohol (Celanese Corp.) at 10 wt. %; and
(6) 0.9 g of CARTABOND GHF glyoxal (Clariant) at 46 wt. %.
   Inventive Coating Composition B (Pigment 95:5 ALBACAR HO PCC to HYDROCARB 90 GCC):
(1) 5.0 g of HYDROCARB 90 ground calcium carbonate (Omya, Inc.) at 76 wt. %;
(2) 97.5 g of ALBACAR HO-40 precipitated calcium carbonate (Specialty Minerals Inc.) at 39 wt. %;
(3) 0.3 g of COLLOID 211 polyacrylate dispersant (Kemira) at 43 wt. %;
(4) 32.2 g of ALBACAR HO precipitated calcium carbonate (Specialty Minerals Inc.) at 100 wt. %;
(5) 8.2 g of styrene-butadiene latex CP692NA® (Dow Chemical Co.) at 49 wt. %;
(6) 16.0 g of CELVOL 325 polyvinyl alcohol (Celanese) at 10 wt. %; and
(7) 0.9 g of CARTABOND GHF glyoxal (Clariant) at 46 wt. %.
   Inventive Coating Composition C (Pigment 90:10 ALBACAR HO PCC to HYDROCARB 90 GCC):
(1) 9.7 g of HYDROCARB90 GCC ground calcium carbonate (Omya, Inc.) at 76 wt. %;
(2) 95.7 g of ALBACAR HO-40 precipitated calcium carbonate (Specialty Minerals Inc.) at 39 wt. %;
(3) 0.3 g of COLLOID 211 polyacrylate dispersant (Kemira Corp.) at 43 wt. %;
(4) 29.3 g of ALBACAR HO precipitated calcium carbonate (Specialty Minerals Inc.) at 100 wt. %;
(5) 8.2 g of styrene-butadiene latex CP692NA® (Dow Chemical Co.) at 49 wt. %;
(6) 16.0 g of CELVOL 325 polyvinyl alcohol (Celanese Corp.) at 10 wt. %; and
(7) 0.9 g of CARTABOND GHF glyoxal (Clariant Corp.) at 46 wt. %.

The state of each of the Coating Compositions A, B, and C was observed immediately upon mixing and again after 24 hours standing.

Comparative Coating Composition A had the Consistency of Paste Upon Preparation and was not Coatable.

Inventive Coating Compositions B and C were fluid upon mixing and also upon standing for 24 hours. This shows that a minimum of 5 weight percent of the non-scalenohedral ground calcium carbonate maintained the coatability of the coating compositions containing the scalenohedral precipitated calcium carbonate.

### Example 3

This example showed the effect of varying the composition on absorption characteristics of an inkjet image-recording element. In this example, the following inorganic particles were used: ALBACAR HO-40 scalenohedral-shaped precipitated calcium carbonate at 40% solids, Specialty Minerals, Inc.; and HYDROCARB 90 ground calcium carbonate at 76% solids, Omya, Inc.

Base layer coating compositions B-1 to B-8 were prepared according to the following formula: 92.35 parts by weight inorganic particles, 5 parts by weight styrene-butadiene latex CP692NA (Dow Chemicals) at 49% solids, 2 parts by weight poly(vinyl alcohol) CELVOL 325 (Celanese Corporation) at 10% solids, 0.5 parts by weight CARTABOND GHF glyoxal crosslinker (Clariant Corporation) at 46% solids, 0.15 parts by weight polyacrylate COLLOID 211 (Kemira Chemicals, Inc.) at 43% solids, and water in sufficient quantity to make a final base coating solution of 40% solids. The inorganic particles (all calcium carbonate) in each of the base layer coating compositions were as given in Table 1 below:

TABLE 1

| | | Ground |
|---|---|---|
| Base Coating | Scalenohedral | Calcium |
| Composition | PCC | Carbonate |
| Comparative | | 100% |
| B-1 | | |
| Comparative | 20% | 80% |
| B-2 | | |
| Comparative | 30% | 70% |
| B-3 | | |
| Comparative | 40% | 60% |
| B-4 | | |
| B-5 | 50% | 50% |
| B-6 | 60% | 40% |
| B-7 | 95% | 5% |
| Comparative | 100% | |
| B-8 | | |

The base layer coating compositions B-1 to B-8 were bead-coated on to 65# QUANTUM Smooth cover paper (Domtar, Inc.) to yield a dry coating weight of approximately 27 g/m² for corresponding the base-coated papers P-1 to P-8.

These base-layer-coated papers were evaluated for ink absorption using the Bristow test method, described in ASTM test method D 5455. Fifty microliters of control ink, comprising 3 parts by weight BAYSCRIPT Cyan BA cyan dye (Bayer Chemical), 12 parts by weight diethylene glycol, 0.5 parts by weight SURFYNOL 465 (Air Products), 0.02 parts by weight PROXEL GXL biocide (Avecia), 0.3 parts by weight triethanolamine at 10%, and 84.18 parts by weight water, was measured into the application hopper. Bristow ink absorption values for each of the base-layer-coated papers were measured at a wheel rotational speed of 0.5 mm/s and 0.1 MPa hopper pressure and the results are shown in Table 2 below.

TABLE 2

| | | Bristow Ink Absorption |
|---|---|---|
| Base-coated papers | | (ml/m²) |
| P-1 | Comp. | 10.1 |
| P-2 | Comp. | 16.5 |
| P-3 | Comp. | 22.5 |
| P-4 | Comp. | 26.1 |
| P-5 | Inv. | 39.6 |
| P-6 | Inv. | 51.6 |
| P-7 | Inv. | 94.3 |
| P-8 | Comp. | 92.6 |

As can be seen from Table 2 above, the structured pigment ALBACAR HO PCC, by itself, in P-8, provides excellent ink absorption rate when coated as a base layer (even though such compositions failed the shear testing as described in previous examples). Up to 55% of a ground pigment such as HYDROCARB 90 GCC may be substituted in the coating composition for ALBACAR HO PCC while maintaining an acceptable Bristow value of substantially above 25 ml/m².

To prepare image-recording elements, the base-coated papers P-1 to P-8 were overcoated with a top coating composition yielding a dry coating weight of approximately 5 g/m². The top coating solution was prepared by mixing the following components: 87.02 parts by weight CATAPAL 200 alumina (Sasol) at 35% solids, 3.77 parts by weight of a core/shell particle emulsion, 40% solids, as prepared by the procedure as described in Example 1 of U.S. Pat. No. 6,440,537, 3.75 parts by weight of GOHSENOL GH-17 poly(vinyl alcohol) (Nippon Gohsei Co., Ltd.) at 10% solids, 5 parts by weight of poly(vinylbenzyl trimethylammonium chloride-co-divinylbenzene) (87:13 molar ratio) emulsion at 15% solids, 0.15 parts by weight nitric acid, 0.62 parts by weight surfactant SILWET L-7602 (General Electric) at 100% active, 0.31 parts by weight surfactant SILWET L-7230 (General Electric) at 30% active, and water to make a final top coating solution at 20% solids.

After the coatings were dried, they were calendered at 500 psi and 115° F. Samples were then evaluated for ink absorption using the Bristow method previously described. The Bristow ink absorption values for the calendered top coated samples are shown in Table 3.

TABLE 3

| | Bristow Ink | |
|---|---|---|
| Top Coated | Absorption | Inventive or |
| Paper | (ml/m²) | Comparative |
| 1 | 10.4 | Comp. |
| 2 | 13.0 | Comp. |
| 3 | 13.4 | Comp. |
| 4 | 14.3 | Comp. |
| 5 | 16.0 | Inv. |
| 6 | 17.6 | Inv. |
| 7 | 19.5 | Inv. |
| 8 | 17.6 | Comp. |

The results in Table 3 show that an image-recording element comprising both a base layer and a top layer, wherein the base layer comprises solid particles comprising at least 45% by weight of scalenohedral-shaped PCC and at least 5% by weight of ground calcium carbonate particles provided an excellent ink absorption rate of at least 15 ml/m².

The invention has been described with reference to a preferred embodiment. However, it will be appreciated that variations and modifications can be effected by a person of ordinary skill in the art without departing from the scope of the invention.

1. An inkjet recording element comprising a support having thereon:
(a) a porous image-receiving layer; and
(b) under the porous image-receiving layer, a porous base layer comprising a polymeric binder and at least 80 percent by weight of inorganic particles, wherein at least 60 percent by weight of the inorganic particles comprise calcium carbonate particles, and wherein the calcium carbonate particles comprise at least 45 percent by weight of precipitated calcium carbonate particles, having scalenohedral morphology, and at least 5 percent by weight of ground calcium carbonate particles.

2. The inkjet recording element of claim 1 wherein the median particle size of the precipitated calcium carbonate particles having scalenohedral morphology is 0.1 to 5 micrometers.

3. The inkjet recording element of claim 1 wherein the calcium carbonate particles comprise at least 10 percent by weight of ground calcium carbonate particles.

4. The inkjet recording element of claim 1 wherein the base layer further comprises up to 30 percent by weight solids of silica gel, based on the total weight of the inorganic particles.

5. The inkjet recording element of claim 1 wherein the base layer further comprises up to 30 percent by weight solids of precipitated calcium carbonate particles having other than scalenohedral morphology.

6. The inkjet recording element of claim 5 wherein the precipitated calcium carbonate particles having other than scalenohedral morphology have prismatic, rhombohedral, or acicular morphology.

7. The inkjet recording element of claim 1 wherein the polymeric binder in the porous base layer is present in the amount of 2 to 20 percent by weight solids.

8. The inkjet recording element of claim 1 wherein the support is porous raw absorbent paper.

9. The inkjet recording element of claim 1 wherein the base layer is calendered.

10. The inkjet recording element of claim 1 wherein the polymeric binder in the porous base layer comprises poly(vinyl alcohol).

11. The inkjet recording element of claim 10 wherein the porous base layer further comprises crosslinker for the poly(vinyl alcohol).

12. The inkjet recording element of claim 1 wherein the porous base layer further comprises polymeric latex.

13. The inkjet recording element of claim 12 wherein the polymeric latex is styrene-butadiene polymer.

14. The inkjet recording element of claim 1 consisting essentially of the porous image-receiving layer and the porous base layer over the support.

15. The inkjet recording element of claim 1 wherein the calcium carbonate particles in the porous base layer consist substantially of ground calcium carbonate particles and precipitated calcium carbonate particles having scalenohedral morphology.

16. The inkjet recording element of claim 1 wherein the porous image-receiving layer comprises inorganic particles dispersed in a polymeric binder, wherein the inorganic particles have a median particle size under 300 nm, in colloidal or aggregated form, and are selected from the group consisting of fumed alumina, hydrated alumina, fumed silica, colloidal silica, and mixtures thereof, wherein the volume ratio of the particles to the polymeric binder is from about 1:1 to about 15:1.

17. The inkjet recording element of claim 1 wherein the porous image-receiving layer further comprises polymeric mordant.

18. An inkjet printing process, comprising the steps of:
(A) providing an inkjet printer that is responsive to digital data signals;
(B) loading the printer with an inkjet recording element as described in claim 1;
(C) loading the printer with an inkjet ink composition; and
(D) printing on the inkjet recording element using the inkjet ink composition in response to the digital data signals.

19. A method of manufacturing an inkjet recording element comprising forming a porous base layer over a substrate by coating, using a post-metered coating method, an aqueous coating composition comprising at least 40 percent by weight solids, which solids comprise a polymeric binder and at least 80 percent by weight of inorganic particles, wherein at least 60 percent by weight of the inorganic particles comprise calcium carbonate, the calcium carbonate comprising at least 45 percent by weight of scalenohedral calcium carbonate particles and at least 5 percent by weight of ground calcium carbonate.

20. The method of claim 19 wherein the coated composition is dried, calendered, and overcoated, directly or indirectly, with another coating composition for a porous image-receiving layer.
